(19) United States
(12) Patent Application Publication
(10) Pub. No.: US 2026/0346708 A1
(43) Pub. Date: Nov. 5, 2026

(54) PUBLIC SAFETY SYSTEM

(71) Applicant: Donta Reshun Lott, Chicago, IL (US)

(72) Inventor: Donta Reshun Lott, Chicago, IL (US)

(21) Appl. No.: 19/195,908

(22) Filed: May 1, 2025

(51) Int. Cl. B60K 35/10; B60K 35/28; G06V 20/56; G06V 20/62

(52) U.S. Cl. CPC B60K 35/10; B60K 35/28; G06V 20/56; G06V 20/625; B60K 2360/119; B60K 2360/166; B60K 2360/176; B60K 2360/178; B60K 2360/332; B60K 2360/589

(57) ABSTRACT

A public safety system includes a housing, a camera, a user interface, a communication interface, and a plurality of input buttons. The plurality of input buttons include an emergency button, a crime-in-progress button, a roadside-assistance button, a police button, and a hospital button. The public safety system includes a controller in communication with the camera, the user interface, the communication interface, and the plurality of input buttons. The controller is configured to instruct the communication interface to place an emergency call, instruct the camera to capture an image, instruct the communication interface to place a roadside assistance call, instruct the user interface to display directions to a nearest police station on the display, and instruct the user interface to display directions to a nearest hospital on the display in response to inputs from the input buttons.

### BACKGROUND

Public safety systems can be used to monitor a state of a vehicle as well as an external environment that the vehicle is within.

### SUMMARY

At least one embodiment relates to a public safety system. The public safety system includes a housing and a camera arranged on a first side of the housing. The camera is configured to selectively capture image data. The public safety system includes a user interface arranged on a second side of the housing. The user interface includes a display that is configured to display the image data. The public safety system includes a communication interface and a plurality of input buttons. The plurality of input buttons include an emergency button, a crime-in-progress button, a roadside-assistance button, a police button, and a hospital button. The public safety system includes a controller in communication with the camera, the user interface, the communication interface, and the plurality of input buttons. The controller is configured to: in response to an input to the emergency button, instruct the communication interface to place an emergency call, in response to an input to the crime-in-progress button, instruct the camera to capture an image, in response to an input to the roadside-assistance button, instruct the communication interface to place a roadside assistance call, in response to an input to the police button, instruct the user interface to display directions to a nearest police station on the display, and in response to an input to the hospital button, instruct the user interface to display directions to a nearest hospital on the display.

At least one embodiment relates to a public safety system. The public safety system includes a housing, a camera arranged on a first side of the housing and configured to selectively capture image data, a user interface arranged on a second side of the housing, a communication interface, a plurality of input buttons, and a plurality of light indicators on the first side of the housing. The plurality of light indicators include a first light indicator, a second light indicator, and a third light indicator. Each of the first light indicator, the second light indicator, and the third light indicator is a different color. The public safety system includes a controller in communication with the camera, the user interface, the communication interface, the plurality of input buttons, and the plurality of light indicators. The controller is configured to: instruct the first light indicator to blink in response to receiving a vehicle incident alert, instruct the second light indicator to blink in response to receiving an invalid insurance alert, and instruct the third light indicator to blink in response to receiving an invalid license alert.

At least one embodiment relates to a public safety network. The public safety system includes two or more public safety systems including a housing, a camera arranged on a first side of the housing and configured to selectively capture image data, a user interface arranged on a second side of the housing, a communication interface, and a plurality of input buttons. The plurality of input buttons include an emergency button, a crime-in-progress button, a roadside-assistance button, a police button, and a hospital button. The public safety systems include a plurality of light indicators on the first side of the housing, wherein the plurality of light indicators include a first light indicator, a second light indicator, and a third light indicator, and wherein each of the first light indicator, the second light indicator, and the third light indicator is a different color. The public safety systems include a controller in communication with the camera, the user interface, the communication interface, the plurality of input buttons, and the plurality of light indicators. One of the two or more public safety systems is coupled to a first vehicle and another of the two or more public safety systems is coupled to a second vehicle. The controller is configured to send information from the public safety systems to a cloud network.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front view of a public safety system, according to an exemplary embodiment;

FIG. 2 is a rear view of the public safety system of FIG. 1;

FIG. 3 is a top view of the public safety system of FIG. 1;

FIG. 4 is a side view of the public safety system of FIG. 1;

FIG. 5 is a side view of the public safety system of FIG. 1;

FIG. 6 is a control diagram of the public safety system of FIG. 1;

FIG. 7 is a network diagram of the public safety system of FIG. 1;

FIG. 8 is a network system of a public safety system, according to an exemplary embodiment;

FIG. 9 is a network system of a public safety system, according to an exemplary embodiment;

FIG. 10 is a front view of a public safety system, according to an exemplary embodiment;

FIG. 11 is a front view of a public safety system, according to an exemplary embodiment;

FIG. 12 is a front view of a public safety system, according to an exemplary embodiment;

FIG. 13 is a front view of a public safety system, according to an exemplary embodiment;

FIG. 14 is a front view of a public safety system, according to an exemplary embodiment;

FIG. 15 is a front view of a public safety system, according to an exemplary embodiment;

FIG. 16 is a front view of a public safety system, according to an exemplary embodiment;

FIG. 17 is a front view of a public safety system, according to an exemplary embodiment;

FIG. 18 is a front view of a public safety system, according to an exemplary embodiment;

FIG. 19 is a front view of a public safety system, according to an exemplary embodiment;

FIG. 20 is a front view of a public safety system, according to an exemplary embodiment;

FIG. 21 is a front view of a public safety system, according to an exemplary embodiment; and

FIG. 22 is a front view of a public safety system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

In general, the present disclosure relates to a public safety system that is configured to provide and receive information related to an external environment. The public safety system uses data about road conditions, emergency vehicles, surrounding vehicles, and weather information, among others, to provide a user of the public safety system with important information and real-time updates. The public safety system includes a camera, a communication interface, a user interface, and a controller that allows for information to be sent out and received.

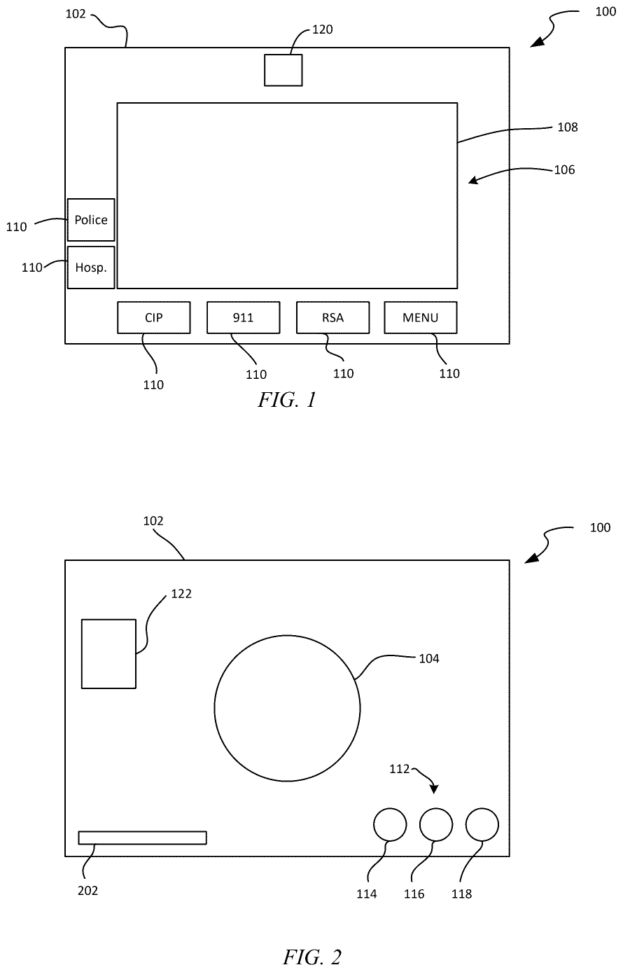

Referring to FIGS. 1-5, a public safety system 100 is shown according to an exemplary embodiment. The public safety system 100 is configured to be placed within a vehicle. For example, the public safety system 100 can be positioned in a truck, a car, a passenger vehicle, a motorcycle, a recreational vehicle, etc. In various embodiments, the public safety system 100 may have different modes dependent on a type of vehicle the public safety system 100 is positioned in. For example, the public safety system 100 may have a mode for vehicles that require a Commercial Driver's Licenses (e.g., a semi-truck or bus). The public safety system 100 includes a housing 102. The housing 102 holds a number of components of the public safety system 100.

The public safety system 100 also includes a camera 104. The camera 104 is arranged on a first side of the housing 102. When the public safety system 100 is positioned in a vehicle, the first side of the housing 102 may be a side that faces an external environment such that the camera 104 can capture image data. For example, the first side of the housing 102 and the camera 104 may face a front windshield of the vehicle. The camera 104 is configured to selectively capture image data. The camera 104 may be a 4K and/or a night vision camera to ensure that image data is being captured at a proper quality. The image data captured from the camera 104 can be used to determine vehicle description, read license plates, and capture accidents (e.g., hit & run, vehicle), shootings, theft, kidnapping, reckless driving, drug and/or gang related activities, and illegal driving (e.g., illegal lane changes, running red lights and stop lights, driving on a shoulder of a road, tailgating, etc.).

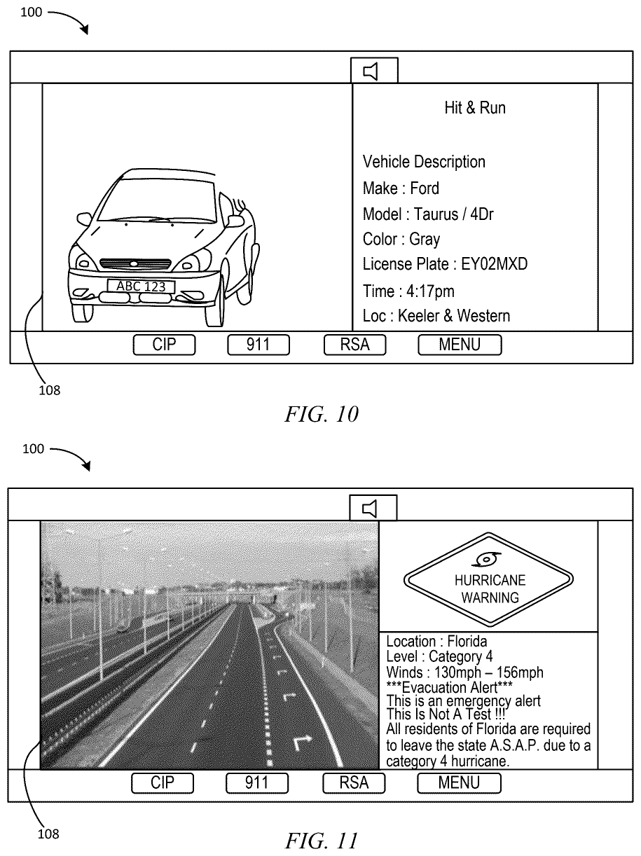

The public safety system 100 includes a user interface 106. The user interface 106 is arranged on a second side of the housing 102. The second side of the housing 102 is a side opposite of the first side of the housing 102. When the public safety system 100 is positioned in a vehicle, the second side of the housing 102 may be a side that faces into the vehicle such that a user or passenger of the vehicle can view the second side of the housing 102 and the user interface 106 while operating the vehicle. The user interface 106 includes a display 108. The display 108 is configured to display the image data (e.g., as shown in FIGS. 10-22). For example, the display 108 may display traffic data, road and highway safety signs, and real-time updates to road conditions (e.g., road closures, traffic accidents, detours, etc.).

The public safety system 100 includes a plurality of input buttons 110. The plurality of input buttons 110 are positioned (e.g., mounted) on the second side of the housing 102. In some embodiments, the plurality of input buttons 110 are physical buttons mounted on the second side of the housing 102. In some embodiments, the plurality of input buttons 110 may be virtual buttons on the user interface 106 (e.g., on the display 108). As shown in FIG. 1, the plurality of input buttons 110 include an emergency (911) button, a crime-in-progress (CIP) button, a roadside-assistance (RSA) button, a police button, and a hospital button. The emergency button allows for a user to call an emergency hotline (e.g., 911) to emergency management. The CIP button allows a user to record (e.g., with the camera 104) and report a crime or accident in real-time to local authorities. In various embodiments, the report can be done anonymously. The RSA button connects a user to a nearby roadside assistance company (e.g., a tow truck company) in an event that the vehicle of the public safety system 100 breaks down or needs assistance. The police and the hospital button allow to user to directly contact a police station or a hospital, respectively, in an emergency.

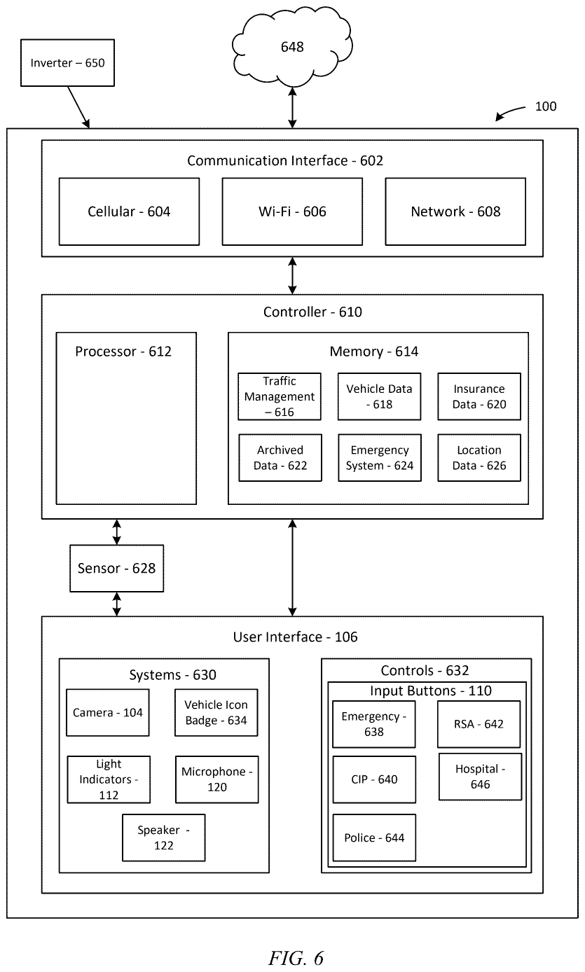

The public safety system 100 includes a plurality of light indicators 112. The plurality of light indicators 112 are positioned on the first side of the housing 102. As shown in FIG. 2, the plurality of light indicators 112 includes a first light indicator 114, a second light indicator 116, and a third light indicator 118. Each of the plurality of light indicators 112 may be distinct in color. For example, the first light indicator 114 may be a red color, the second light indicator 116 may be a yellow color, and the third light indicator 118 may be a green color. The first light indicator 114, the second light indicator 116, and the third light indicator 118 are configured to signal different alerts. As described herein, in reference to FIG. 6, the first light indicator 114 can represent a vehicle incident, the second light indicator 116 can represent an invalid insurance, and the third light indicator 118 can represent an invalid license.

In various embodiments, the public safety system 100 includes a microphone 120 and a speaker system 122. The microphone 120 is positioned on the second side of the housing 102 and the speaker system 122 is positioned on the first side of the housing 102. The microphone 120 and the speaker system 122 allows for a user of the public safety system 100 to communicate with other personnels. For example, the microphone 120 and the speaker system 122 allows for the user to communicate with first responders after using the emergency button. In another example, the microphone 120 and the speaker system 122 allows the user to communicate with a tow truck company after using the RSA button. In various embodiments, as shown in FIG. 5, the public safety system 100 may include volume buttons 502 to adjust a volume of the speaker system 122 during use of the speaker system 122 (e.g., communication with other personnels).

In various embodiments, the public safety system 100 may also include a toll transponder. The toll transponder may be arranged on the first side of the housing 102. The toll transponder can be used to decrease tollbooth traffic time and speed up traffic flow at tolls. The toll transponder and the public safety system 100 with the toll transponder may be distributed to users depending on toll collection coverage area. For example, the toll transponder for with California may be distributed to Californian users, while the toll transponder for east coast states may be distributed to east coast users.

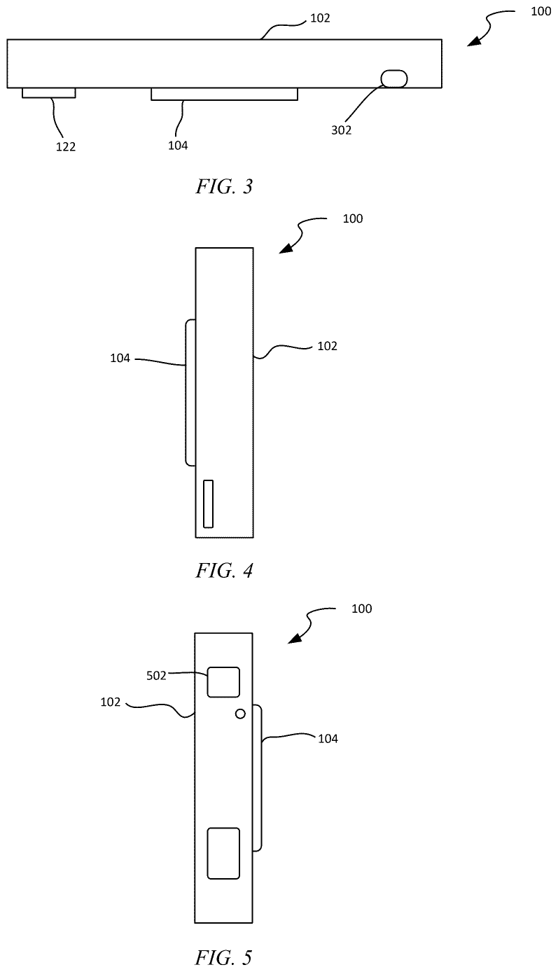

The public safety system 100 may also include a power button 302, as shown in FIG. 3. The power button 302 allows for a user to power on and off the public safety system 100. The power button 302 may be positioned on a top side of the housing 102.

As shown in FIG. 2, in various embodiments, the first side of the housing 102 includes an identification label 202. The identification label 202 is a unique code for each of the public safety systems 100. For example, the identification label 202 may be a serial number (e.g., SN: 1234567890). The identification label 202 may be used for device identification and in various embodiments, can be linked to an owner of the public safety system.

FIG. 6 shows a control diagram of the public safety system 100. The public safety system 100 can use an inverter 650 as a power source to continuously run the public safety system 100. In various embodiments, the inverter 650 is between 400 Watts and 650 Watts, inclusive. As shown in in FIG. 6, the public safety system 100 includes a communication interface 602. The communication interface 602 provides an interface and way for the public safety system 100 to connect to an communicate with an external environment. The communication interface 602 includes at least one of cellular 604, Wi-Fi 606, and network 608. The communication interface 602 allows for calls to be made, image data to be sent out to proper personnels, and road conditions to be displayed on the display 108, among other things.

The public safety system 100 also includes a controller 610 as shown in FIG. 6. The controller 610 includes one or more processors 612 and memory 614 to compute required operations to operate the public safety system 100. The memory 614 is configured to store a number of information related to the public safety system 100, the vehicle of the public safety system 100, and the external environment of the vehicle. The memory 614 may store information related to traffic management 616 (e.g., road conditions, detours, road closures, etc.), vehicle data 618, insurance data 620, archived data 622, emergency system 624, and location data 626.

The traffic management 616 includes a number of events related to traffic, public safety, etc. The events may be detected and/or reported by the camera 104 or by the plurality of input buttons 110. The vehicle data 618 includes information related to the vehicle such as a type of car, a license plate number, etc. In various embodiments, the vehicle data 618 may also include information related to vehicle status (e.g., vehicle emission, vehicle registration, etc.). The vehicle status may be stored in the memory 614 and reminders on upcoming deadlines may be displayed on the display 108. For example, the display 108 may display a reminder related to vehicle emission.

The archived data 622 is used to collect, archive, manage, and distribute information for use in transportation, administration, safety, planning, and operations, among other. The archived data 622 uses data collected from roadside and traffic to prepare reporting inputs. Data from all the public safety systems 100 can be archived for traffic management, public safety, and planning.

The location data 626 corresponds to location information of the public safety system 100. The location data 626 can include past location, current location, and future/planned location of the public safety system 100. The public safety system 100 may include a global positioning system (GPS) to receive the location data 626. The location data 626 is in communication with the controller 610 such that the controller 610 received information on a location of the public safety system 100. The location data 626 can be used to display directions to a nearest police station or nearest hospital. Additionally, the location data 626 can be used to direct personnels (e.g., an emergency vehicle, roadside assistance vehicle, etc.) to the current location of the public safety system 100.

The controller 610 is in communication with the camera 104, the user interface 106, the communication interface 602, the plurality of input buttons 110, and the plurality of light indicators 112. The controller 610 may also be in communication with the microphone 120 and the speaker system 122. As shown in FIG. 6, the public safety system 100 may include a sensor 628 communicatively coupled to the controller 610 and the user interface 106. The sensor 628 can receive information from the user interface 106 (e.g., the camera 104, etc.) and this information can be received by the controller 610 to perform operations.

As shown in FIG. 6, the user interface 106 may include systems 630 and controls 632. The systems 630 include the camera 104, the plurality of light indicators 112, the microphone 120, the speaker system 122, and a vehicle icon badge 634. The controller 610 may be in communication with the systems 630 and the controls 632 via the user interface 106. In various embodiments, the controller 610 is configured to instruct the camera 104 to capture a video footage. In various embodiments, the image data from the housing 102 includes an image and a video. The controller 610 can be configured to identify a characteristic using at least one of the image or the video. For example, the characteristic can include at least one of a license plate, an individual, or an environment. With this identification, the controller 610 may determine a state of an environment following an accident, identify vehicles involved in criminal activities, recognize individuals involved in crimes, and analyze other events using the camera 104.

In reference to the plurality of light indicators 112, the controller 610 may be configured to control the plurality of light indicators 112. The controller 610 can instruct the first light indicator 114 to blink in response to receiving a vehicle incident alert. The vehicle incident alert can include hit & run accidents, stolen vehicle, kidnapping, public shooting, among other vehicle incidents. The blinking first light indicator 114 indicates that the vehicle has been tagged by other public safety system 100 and/or emergency calls for at least one vehicle incident. In various embodiments, the vehicle incident alert includes an indication that a vehicle with a second public safety system 100 is reported in an incident if the second public safety system 100 is within a predetermined distance of the public safety system 100. In this embodiment, the public safety system 100 can inform a user of nearby incidents involving vehicles with the public safety system 100. In various embodiments, the controller 610 instructs the first light indicator 114 to continuously illuminate in response to not being involved in a crime. The controller 610 can instruct the second light indicator 116 to blink in response to receiving an invalid insurance alert. For example, the invalid insurance alert may be from an insurance company (e.g., American Insurance Association (AIA) company). The invalid insurance alert represents that a vehicle insurance of the vehicle is not valid. In various embodiments, the controller 610 instructs the second light indicator 116 to continuously illuminate in response to receiving a valid insurance alert, representing that the vehicle insurance is valid. The controller 610 can control the third light indicator 118 to blink in response to receiving an invalid license alert. For example, the invalid license alert can be from a government agency (e.g., Secretary of State). The invalid license alert may represent that a license of a user of the vehicle is not valid (e.g., expired, revoked, suspended, etc.). In various embodiments, the characteristic identified by the controller 610 using the camera 104 may include a license plate. The controller 610 can receive the invalid license alert using the identifies license plate. In various embodiments, the controller 610 instructs the third light indicator 118 to continuously illuminate in response to receiving a valid license alert, representing that the license is valid.

The vehicle icon badge 634 is configured to label a vehicle of the public safety system 100. The vehicle icon badge 634 may be for internal use due to privacy rights. As a results, the vehicle icon badge 634 may not be displayed on the display 108. Different colors and/or symbols of the vehicle icon badge 634 can be used to represent different vehicles. For example, passenger and commercial vehicles may have a vehicle icon badge 634 that is a first color (e.g., green). Police offices may have a vehicle icon badge 634 that is a second color different than the first color (e.g., blue). Additionally, ambulance vehicles and fire truck vehicles may also have a vehicle icon badge 634 that is a different color. For example, ambulance vehicle may have a while color and fire truck vehicle may have a purple color. The vehicle icon badge 634 may also be used to identify vehicles of users involved in crime. For example, vehicles belonging to registered crime offenders (e.g., sex offenders) may have a vehicle icon badge 634 that is distinct color (e.g., yellow) different than colors of the other vehicle icon badges 634.

The controls 632 includes the plurality of input buttons 110. The user of the public safety system 100 can interact with the controls 632 to receive specific responses and/or outputs. As described with reference to the plurality of input buttons 110, the plurality of input buttons 110 includes an emergency button 638, a CIP button 640, an RSA button 642, a police button 644, and a hospital button 646. The controller 610 is configured to instruct the communication interface 602 to place an emergency call in response to an input to the emergency button 638. The controller 610 is configured to instruct the camera 104 to capture an image in response to an input to the CIP button 640. The image can be sent to emergency personnels and used to report a crime. The controller 610 is configured to instruct the communication interface 602 to place a roadside assistance call in response to an input to the RSA button 642. The controller 610 is configured to instruct the user interface 106 to display directions to a nearest police station on the display 108 in response to an input to the police button 644. The controller 610 is configured to instruct the user interface 106 to display directions to a nearest hospital on the display 108 in response to an input to the hospital button 646.

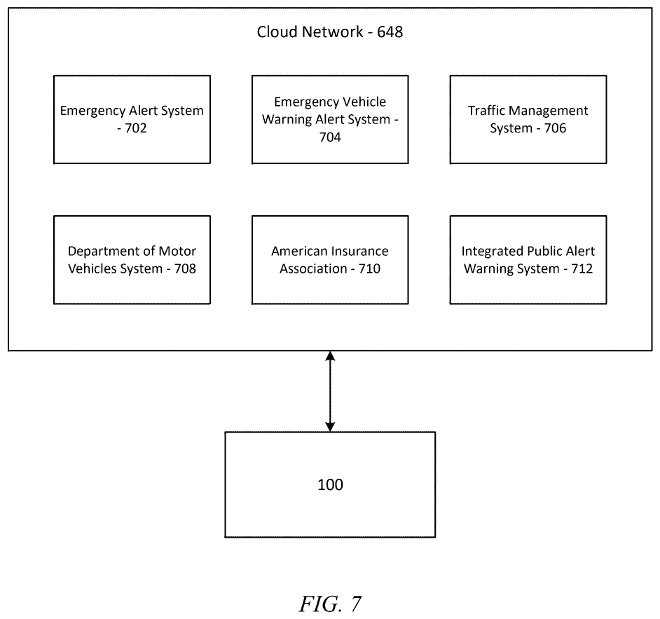

As shown in FIGS. 6 and 7, the public safety system 100 is communicatively coupled to a cloud network 648. The cloud network 648 can include a number of systems and information to communicate and receive data to and from the public safety system 100 and a number of other public safety systems 100. For example, the controller 610 can be configured to capture information from the camera 104 and send the information to the cloud network 648. This can be used to communication information after an accident occurs and/or after the controller 610 receives an input from one of the plurality of input buttons 110 (e.g., the CIP button 640). Additionally, the cloud network 648 can be used to communicate information regarding the plurality of light indicators 112. For example, the cloud network 648 can include vehicle information and the controller 610 can receive information for at least one of the alerts related to the plurality of light indicators 112 (e.g., the vehicle incident alert, the invalid insurance alert, the invalid license alert) from the cloud network 648.

As shown in FIG. 7, the cloud network 648 includes an emergency alert system 702, an emergency vehicle warning alert system 704, a traffic management system 706, department of motor vehicles system 708, insurance association 710, and an integrated public alert warning system 712. The emergency alert system 702 is a framework adopting a Common Alerting Protocol (CAP) and is used to provide personnels (e.g., federal, state, territorial, tribal, and local emergency personnels) access to communication pathways (e.g., to and from the public safety system 100). The emergency alert system 702 is used to ensure that alerts and warnings reach a maximum number of people within the area. Additionally, the public safety system 100 can be used to provide the emergency alert system 702 with more information. For example, accidents and incidents reported by the public safety system 100, with the plurality of input buttons 110, can be received by the emergency alert system 702 to send out more detailed alerts and warnings to people.

The emergency vehicle warning alert system 704 uses real-time traffic status that receives and sends signal to and from a road (e.g., traffic light intersections) that an emergency vehicle is approaching. The emergency vehicle warning alert system 704 is communicatively coupled to the public safety system 100 to provide the user a warning that the emergency vehicle is approaching in order to ensure the emergency vehicle has a safe pathway through the road. In various embodiments, the information from the emergency vehicle warning alert system 704 is sent to the controller 610 to instruct the user interface 106 to display an emergency vehicle symbol on the display 108 moving in real-time to match the emergency vehicle's movement.

The traffic management system 706 includes traffic data to provide traffic and incident management services through roadside. Pre-processed data about vehicles passing through a street and freeway network is received by the traffic management system 706. This data along with weather and incident data is used by the traffic management system 706 to create and provide traffic surveillance data within the traffic management system 706. The traffic management system 706 can be used to exchange and communicate information with traffic centers. The traffic management system 706 is communicatively coupled to the public safety system 100 to display road and highway safety signs and provide real-time updates on roads and highways, lane closures, road closures, detours, traffic accidents, construction zones, and road and highway maintenance workers.

The motor vehicles system 708 includes information on driving privileges and license validity. The motor vehicles system 708 can communicate with the plurality of light indicators 112, particularly the plurality of light indicators 112 related to an invalid license alert, to confirm driving privileges of a user of a vehicle. Additionally, the motor vehicles system 708 may be in communication with the memory 614. For example, the motor vehicles system 708 may aid in providing information on the vehicle data 618 and providing vehicle status information (e.g., vehicle emission reminders).

The insurance association 710 includes information on vehicle insurance. In various embodiments, the insurance association 710 is the American Insurance Association (AIA). The public safety system 100 is communicatively coupled to the insurance association 710 to show real-time transparency of registered vehicle and provide proof of valid insurance. For example, the insurance association 710 can be communicatively coupled to the controller 610 such that the controller 610 can instruct the user interface 106 to display a digital version of vehicle insurance on the display 108 to provide proof of insurance. Additionally, information from the insurance association 710 can be used in an accident or crime when reporting the event. The insurance association 710 can communicate with the plurality of light indicators 112, particularly the plurality of light indicators 112 related to an invalid insurance alert, to confirm insurance of a vehicle.

The integrated public alert warning system 712 includes information related to public alerts. For example, the integrated public alert warning system 712 can include information related to mass shootings, terrorist attacks, and weather warnings (e.g., hurricane warning, earthquake warning, flood warning, snowstorm, tornado warning). The integrated public alert warning system 712 can be communicatively coupled to the controller 610 such that the controller 610 can instruct the user interface 106 to display alerts related to the integrated public alert warning system 712 to inform a user of the public safety system 100.

In various embodiments, information from the cloud network 648 can be stored in the memory 614. For example, information from the traffic management system 706 can be stored in the traffic management 616. In another example, information from the insurance association 710 can be stored in the insurance data 620.

The public safety system 100 may be a part of a public safety network such that multiple public safety systems 100 can communicate with each other in order to provide information to a number of users. The public safety network can include two or more of the public safety system 100. One of the public safety systems 100 is configured to be coupled to a first vehicle and another of the public safety systems 100 is configured to be coupled to a second vehicle. The controller 610 of the public safety systems 100 send information from the public safety systems 100 to the cloud network 648. Additionally, information from the cloud network 648 can be sent to the public safety systems 100.

In various embodiments, in response to an input to at least one of the plurality of input buttons 110 (e.g., the emergency (911) button 638 or the CIP button 640) from one of the public safety systems 100, the controller 610 of another of the public safety systems 100 is configured to instruct the user interface 106 to display a message. Such configuration allows for communication on nearby accidents and emergencies to be communicated between the public safety systems 100.

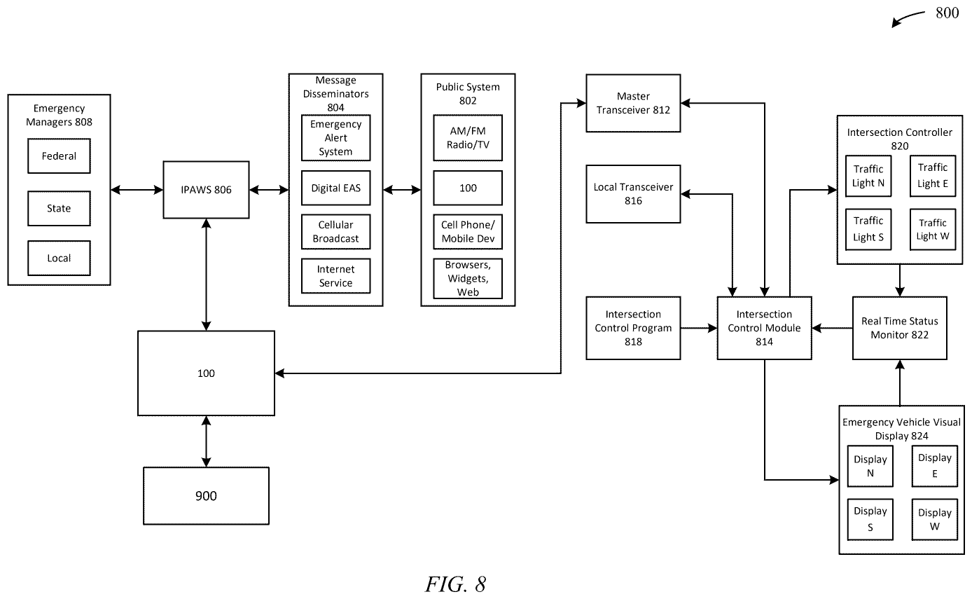

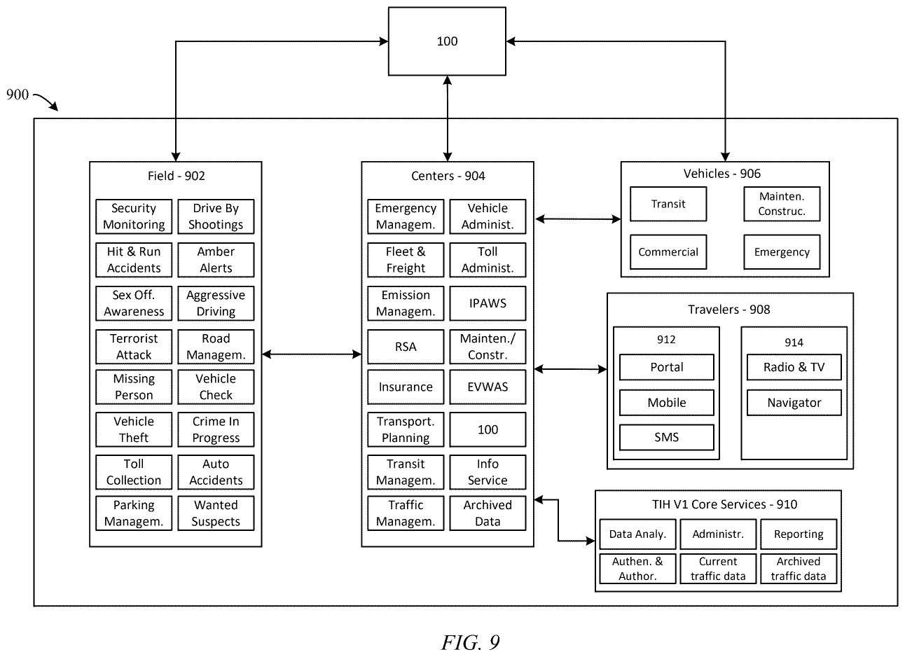

FIGS. 8 and 9 show a network system 800 and a network system 900 including the public safety system 100, according to an exemplary embodiment. The public safety system 100 communicates with a number of systems and networks in order to receive and send information. The public safety system 100 is a part of a public system 802. The public system 802 also includes AM/FM Radio/TV, mobile devices (e.g., cell phones, tablets, etc.), and browsers, widgets, and web. The public system 802 is communicatively coupled to message disseminators 804. The message disseminators 804 relate to systems and methods used for transmitting and relaying information. The message disseminators 804 include an emergency alert system (e.g., emergency alert system 702), cellular broadcast, and internet service.

The message disseminators 804 is communicatively coupled to Integrated Public Alert and Warning System (IPAWS), shown as IPAWS 806. The IPAWS 806 delivers emergency and life-saving information to the public through the message disseminators 804. In various embodiments, the IPAWS 806 is the integrated public alert warning system 712. The IPAWS 806 is communicatively coupled to emergency managers 808 and the public safety system 100. As shown in FIG. 8, the emergency managers 808 is included at a federal, state, and local level.

As shown in FIG. 8, the public safety system 100 can further be connected to networks and transceivers to receive and send out information related to public safety. For example, with the emergency vehicle warning alert system 704, the public safety system 100 may be communicably coupled to a master transceiver 812 communicably coupled to an intersection control module 814. The master transceiver 812 is responsible for communication to and from an operation network The intersection control module 814 is configured to receive and send out information related to intersections and emergency vehicles to determine a location of emergency vehicles in relation to intersections. The intersection control module 814 is communicably coupled to a local transceiver 816, an intersection control program 818, an intersection controller 820, a real time status monitor 822, and an emergency vehicle visual display 824.

The local transceiver 816 is responsible for communication to and from local vehicles and intersections. Local vehicles can be emergency vehicles or passenger vehicles. The intersection control program 818 includes micro-controllers and firmware to manage operations to execute instructions to operate the intersection control module 814. The intersection controller 820 is configured to control traffic lights on intersections. As shown in FIG. 8, the intersection controller 820 can be used to control traffic lights in a number of directions, shown as Traffic Light N for a north direction, Traffic Light S for a south direction, Traffic Light E for an east direction, and Traffic Light W for a west direction. The emergency vehicle visual display 824 is configured for providing updates onto a location of one or more emergency vehicles. The location can be captured among a number of directions, shown as Display N for a north direction, Display S for a south direction, Display E for an east direction, and Display W for a west direction.

The intersection controller 820 sends information to the real time status monitor 822. The real time status monitor 822 is configured to provide real time monitoring and updates as traffic lights change and emergency vehicles pass by intersections. This information is sent to the intersection control module 814, which then uses this information to properly send out information about emergency vehicles and their location, which can be used for the emergency vehicle warning alert system 704.

As shown in FIG. 9, the public safety system 100 is connected to a network system 900. The network system 900 includes field 902, centers 904, vehicles 906, travelers 908, and TIH V1 Core Services 910. Information from the network system 900 is gathered and sent to the public safety system 100 for processing and to send out to the public. Additionally, information from the public safety system 100 can be used by the network system 900 for management and planning.

The field 902 includes information and occurrences that occur in an environment (e.g., a field). The field 902 includes security monitoring, drive by shootings, hit and run accidents, amber alerts, sex offender awareness (sex off. awareness), aggressive driving, terrorist attack, road management (road managem.), missing person, vehicle check, vehicle theft, crime in progress, toll collection, auto accidents, parking management (parking managem.), and wanted suspects, among others. These events that occur in the field 902 are sent to the public safety system 100 to inform the public and improve public safety and awareness.

Information from the field 902 are also sent to the centers 904. The centers 904 includes centers and systems responsible for receiving and sending information. The centers 904 include emergency management (emergency managem.), vehicle administration (vehicle administ.), fleet and freight management, toll administration, emission management, the integrated public alert warning system 712, RSA, maintenance and construction management, insurance companies, the emergency vehicle warning alert system 704, transportation planning, the public safety system 100, transit management, information service provider, traffic management, and archived data management. These centers 904 are configured to receive data and process the data accordingly such that the public can receive information based on the data.

The centers 904 is coupled to the TIH V1 Core Services 910 for managing the data. As shown in FIG. 9, managing and processing the data can include data analysis, administration, reporting, authentication and authorization, current traffic data, and archived traffic data. Any combination of such, among others, may be used for managing the data.

Information reaches the vehicles 906 and the travelers 908. The vehicles 906 includes a number of vehicles such as transit vehicles, commercial vehicles, maintenance construction vehicles, and emergency vehicles. The travelers 908 includes personal information access 912 and remote traveler support 914. The personal information access 912 includes information methods that require personal information, such as portal, mobile, and short message service. The remote traveler support 914 includes radio and television, and navigator (e.g., GPS). As such, the public safety system 100 is configured to be included within this network of sending and receiving information related to public safety.

FIGS. 10-22 show front views of the public safety system 100, according to an exemplary embodiment. FIG. 10 shows a hit and run alert on the display 108 of the user interface 106. The hit and run alert can be displayed in response to an input to the emergency button 638 or the CIP button 640. The hit and run alert can contain information on a nearby vehicle reported as being involved in a hit and run/The information can include vehicle description, time, and location.

FIG. 11 shows a public alert. Information on the public alert can be received by the cloud network 648. For example, the information can be received by the controller 610 from the integrated public alert warning system 712 and displayed on the display 108. The public alert includes information on the weather warning and next step information (evacuation).

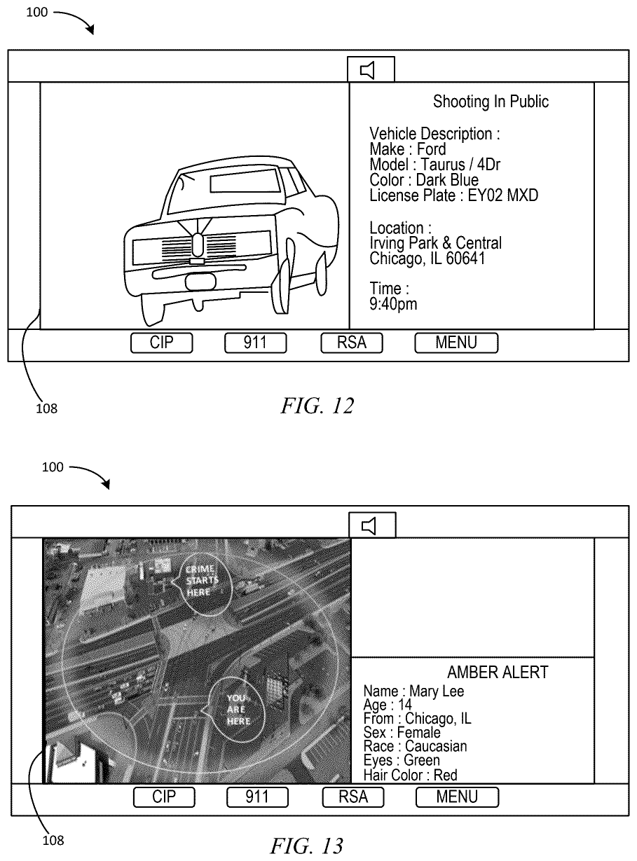

FIG. 12 shows a crime in progress (CIP) alert. The CIP alert relates to a drive-by shooting. The CIP alert can be reported by the public safety system 100 via the CIP button 640. The CIP alert on the display 108 includes vehicle information, location information, and time of incident. Data received by the camera 104 can be sent to the emergency alert system 702. In various embodiments, as described herein, the location information can be received by the location data 626.

FIG. 13 shows an amber alert. The amber alert can be used to report missing children. The amber alert is displayed on the display 108 and includes information related to the missing child(ren). In various embodiments, the amber alert may also include an image of the missing child to inform a user of the public safety system 100. Data received by the camera 104 can be sent to the emergency alert system 702. As shown in FIG. 13, the alert also includes location information on the crime in reference to the current location of the public safety system 100.

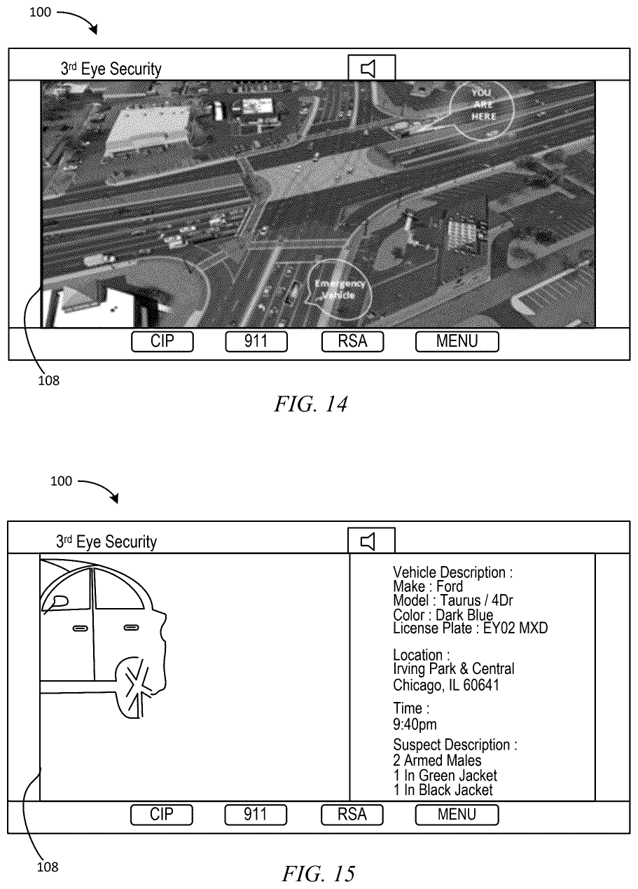

FIG. 14 shows an emergency vehicle warning alert. The emergency vehicle warning alert corresponds to a warning related to an emergency vehicle approaching. The emergency vehicle warning alert may receive information from the cloud network 648. For example, the information can be received by the controller 610 from the emergency vehicle warning alert system 704 and displayed on the display 108. The emergency vehicle warning alert includes an image showing a location of an emergency vehicle and a location of the public safety system 100. The emergency vehicle warning alert can be provided such that the user of the public safety system 100 is informed to slow down and/or stop in order to allow the emergency vehicle to pass.

FIG. 15 shows a CIP alert. The CIP alert relates to a robbery. The CIP alert can be reported by providing an input to the CIP button 640. The CIP alert is displayed on the display 108 and includes an image and/or a video. Additionally, the CIP alert can include vehicle description, location information, and suspect description. The camera 104 and the controller 610 can be used to capture image data and process the image data to identify vehicle and suspect description. Data received by the camera 104 can be sent to the emergency alert system 702

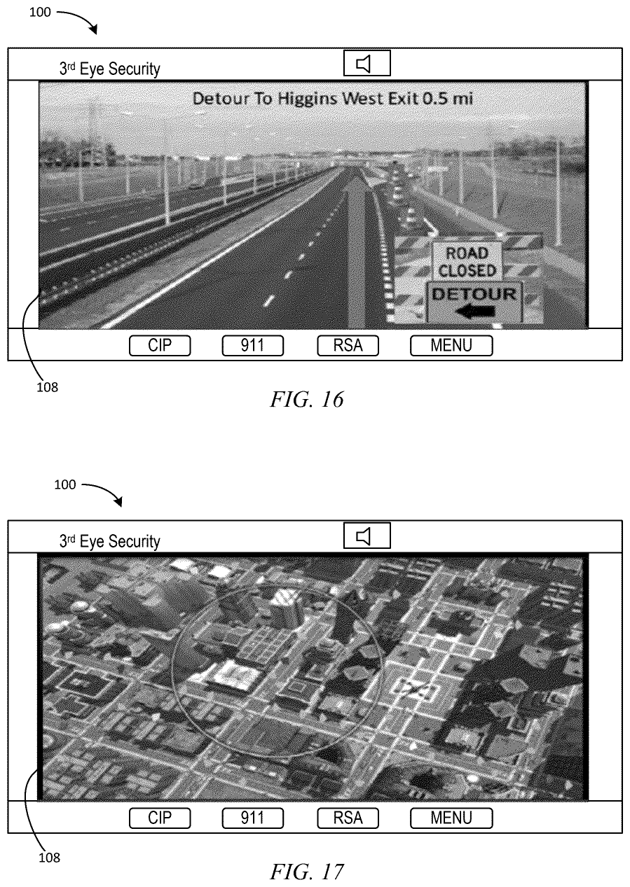

FIG. 16 shows a traffic alert. The traffic alert relates to a detour on a road. In various embodiments, information on the traffic alert may be provided by the traffic management system 706. The traffic alert is displayed on the display 108 and includes information on when the detour is and a direction of the detour. The traffic alert may use the location data 626 to provide location and direction information.

FIG. 17 shows a view of a crime grid displayed on the display 108. In various embodiments, the crime grid provides multiple views of a crime or accident. The views may be provided by multiple public safety systems 100 that are a part of a public safety network and/or all in communication with the cloud network 648. By having a number of views from multiple public safety systems 100, the crime grid can also be used to go backwards in time, using the views, to a previous location of a suspect and/or a vehicle before the crime/accident. This crime grid may be used internally (e.g., by a government agency) due to public safety and privacy rights.

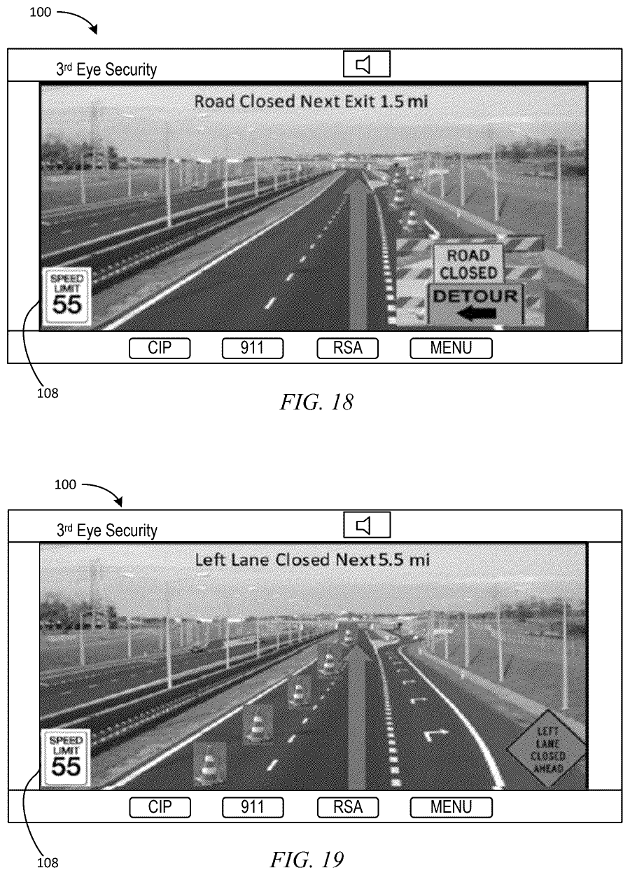

FIG. 18 shows a traffic alert. The traffic alert relates to a road closure. In various embodiments, information on the traffic alert may be provided by the traffic management system 706. The traffic alert is displayed on the display 108 and includes information on when the road closure is and directions for the vehicle of the public safety system 100. As shown in FIG. 18, the traffic alert includes information on a next exit that the vehicle can take. The traffic alert may use the location data 626 to provide location and direction information.

FIG. 19 shows a traffic alert. The traffic alert relates to a lane closure. In various embodiments, information on the traffic alert may be provided by the traffic management system 706. The traffic alert is displayed on the display 108 and includes information on when the lane closure is and directions for the vehicle of the public safety system 100. As shown in FIG. 18, the traffic alert includes information on how long (in miles) the lane closure is. The traffic alert may use the location data 626 to provide location and direction information.

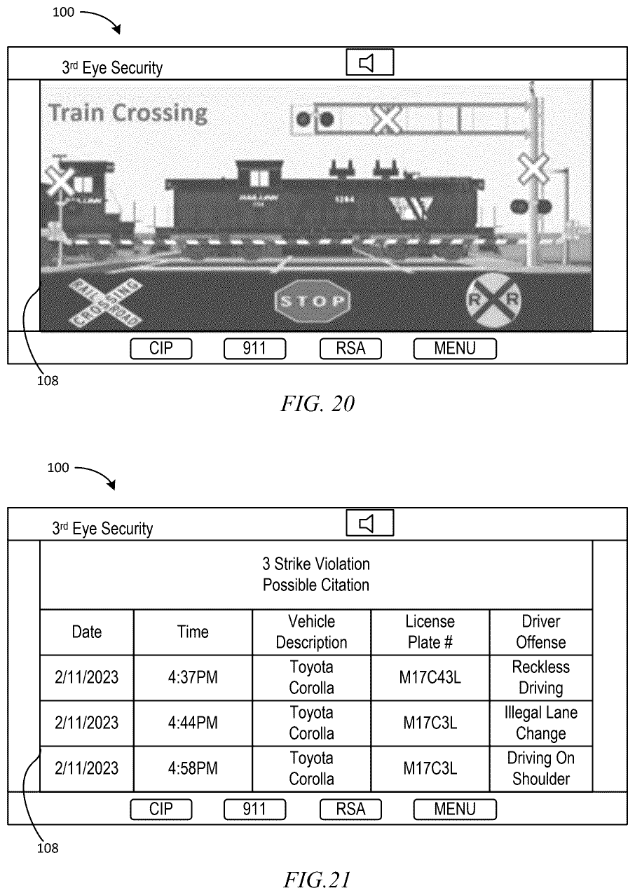

FIG. 20 shows a traffic alert. The traffic alert relates to a train crossing. In various embodiments, information on the traffic alert may be provided by the traffic management system 706. As shown in FIG. 18, the traffic alert includes a visual of the train crossing and safety signs directing a user of the vehicle to stop. The traffic alert may use the location data 626 to provide location and direction information.

FIG. 21 shows a strike alert. The strike alert shown in FIG. 21 relates to a three strike violation. The three strike violation is used to tag vehicles within a vicinity of the public safety system 100 that are driving recklessly or improperly. As shown in FIG. 21, the alert includes vehicle description which may include make, model, color, or license plate number, among others. Vehicles may be tagged as driving improperly by the emergency button 638, the CIP button 640, or the camera 104. The alert may include image data of the vehicle. After a vehicle has been tagged a predetermined number of times (e.g., three, five, etc.), information on the vehicle may be sent to local authorities. The communication interface 602 and the cloud network 648 may be used to send over the information.

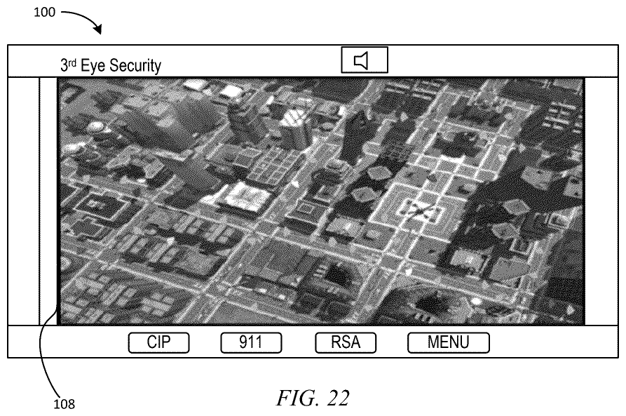

FIG. 22 shows a location grid. The location grid can be used to tag locations where offenders (e.g., sex offenders) are reported at. The public safety system 100 may provide police officers with locations of nearby offenders within a vicinity of a sex related crime. Permission must be granted first. Registered offenders may have their driver's license from a government agency (e.g., Secretary of State, Department of Motor Vehicles, etc.) linked to their public safety system 100 with their real-time status location. This information may only be viewed internally (e.g., by an internal management and/or emergency management) due to public safety and privacy rights. In various embodiments, this information may only be viewable by Homeland Public Security and Emergency Management. Registered offenders may have an icon badge 634 (e.g., of a yellow color) on the display 108 representing their registered vehicle.

Advantageously, the public safety system 100 is a transportation and public technology that will use data gathered from the public safety systems 100 and the cloud network 648 to provide transparency and accountability of crimes and accidents for citizens and first responders. The public safety system 100 will provide faster response time for emergency vehicles, while also fighting vehicle theft and insurance policy fraud by vehicle owners.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

It is important to note that the construction and arrangement of present disclosure as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A public safety system, comprising:
a housing;
a camera arranged on a first side of the housing, the camera configured to selectively capture image data;
a user interface arranged on a second side of the housing, the user interface including a display that is configured to display the image data;
a communication interface;
a plurality of input buttons, wherein the plurality of input buttons include an emergency button, a crime-in-progress button, a roadside-assistance button, a police button, and a hospital button; and
a controller in communication with the camera, the user interface, the communication interface, and the plurality of input buttons, wherein the controller is configured to:
in response to an input to the emergency button, instruct the communication interface to place an emergency call;
in response to an input to the crime-in-progress button, instruct the camera to capture an image;
in response to an input to the roadside-assistance button, instruct the communication interface to place a roadside assistance call;
in response to an input to the police button, instruct the user interface to display directions to a nearest police station on the display; and
in response to an input to the hospital button, instruct the user interface to display directions to a nearest hospital on the display.

2. The public safety system of claim 1, further comprising a plurality of light indicators on the first side of the housing, wherein the plurality of light indicators include a first light indicator, a second light indicator, and a third light indicator, and wherein each of the first light indicator, the second light indicator, and the third light indicator is a different color, the controller is in communication with the plurality of light indicators.

3. The public safety system of claim 2, wherein the controller is further configured to:
instruct the first light indicator to blink in response to receiving a vehicle incident alert;
instruct the second light indicator to blink in response to receiving an invalid insurance alert; and
instruct the third light indicator to blink in response to receiving an invalid license alert.

4. The public safety system of claim 1, wherein the controller is further configured to instruct the camera to capture a video.

5. The public safety system of claim 4, wherein the controller is further configured to identify a characteristic using at least one of the image or the video.

6. The public safety system of claim 5, wherein the characteristic is at least one of a license plate, a person, or an environment.

7. The public safety system of claim 1, wherein the display is configured to display information related to at least one of a road closure or a road detour, the information received by a cloud network.

8. The public safety system of claim 1, wherein the controller is configured to capture information from the camera, the controller to send the information to a cloud network.

9. The public safety system of claim 1, further comprising a location data, the location data in communication with the controller such that controller receives information on a location of the public safety system.

10. The public safety system of claim 9, wherein the controller is configured to use the location data to display directions to at least one of the nearest police station or the nearest hospital.

11. The public safety system of claim 1, further comprising a microphone and a speaker system in communication with the controller.

12. A public safety system, comprising:
a housing;
a camera arranged on a first side of the housing, the camera configured to selectively capture image data;
a user interface arranged on a second side of the housing;
a communication interface;
a plurality of input buttons;
a plurality of light indicators on the first side of the housing, wherein the plurality of light indicators include a first light indicator, a second light indicator, and a third light indicator, and wherein each of the first light indicator, the second light indicator, and the third light indicator is a different color; and
a controller in communication with the camera, the user interface, the communication interface, the plurality of input buttons, and the plurality of light indicators, wherein the controller is configured to:
instruct the first light indicator to blink in response to receiving a vehicle incident alert;
instruct the second light indicator to blink in response to receiving an invalid insurance alert; and
instruct the third light indicator to blink in response to receiving an invalid license alert.

13. The public safety system of claim 12, wherein the vehicle incident alert includes an indication that a vehicle with a second public safety system is reported in an incident, the second public safety system to have a same configuration as the public safety system, the second public safety system within a predetermined distance of the public safety system.

14. The public safety system of claim 12, wherein the controller is communicatively coupled to a cloud network, the cloud network including vehicle information, the controller to receive information for at least one of the vehicle incident alert, the invalid insurance alert, or the invalid license alert from the cloud network.

15. The public safety system of claim 12, wherein the image data includes an image and a video, wherein the controller identifies a characteristic using at least one of the image or the video.

16. The public safety system of claim 15, wherein:
the characteristic includes a license plate; and
the controller is communicatively coupled to a cloud network, the controller to receive the invalid license alert based on information from the cloud network.

17. The public safety system of claim 12, wherein the plurality of input buttons include at least one of an emergency button, a crime-in-progress button, a roadside-assistance button, a police button, or a hospital button.

18. The public safety system of claim 12, wherein the controller is configured to:
instruct the second light indicator to continuously illuminate in response to receiving a valid insurance alert; and
instruct the third light indicator to continuously illuminate in response to receiving a valid license alert.

19. A public safety network, comprising:
two or more public safety systems comprising:
a housing;
a camera arranged on a first side of the housing, the camera configured to selectively capture image data;
a user interface arranged on a second side of the housing;
a communication interface;
a plurality of input buttons, wherein the plurality of input buttons include an emergency button, a crime-in-progress button, a roadside-assistance button, a police button, and a hospital button;
a plurality of light indicators on the first side of the housing, wherein the plurality of light indicators include a first light indicator, a second light indicator, and a third light indicator, and wherein each of the first light indicator, the second light indicator, and the third light indicator is a different color; and
a controller in communication with the camera, the user interface, the communication interface, the plurality of input buttons, and the plurality of light indicators;
wherein one of the two or more public safety systems is coupled to a first vehicle and another of the two or more public safety systems is coupled to a second vehicle, and wherein the controller to send information to a cloud network via the communication interface.

20. The public safety network of claim 19, wherein in response to an input to at least one of the emergency button or the crime-in-progress button, the controller is configured to instruct the user interface to display a message.
